(19) United States
(12) Patent Application Publication
(10) Pub. No.: US 2026/0252717 A1
(43) Pub. Date: Aug. 27, 2026

(54) CONTROLLING RESOURCE ACCESS REQUESTS IN CONTAINERIZED PLATFORM

(71) Applicant: International Business Machines Corporation, Armonk, NY (US)

(72) Inventors: YAN HUANG, Shijingshan District (CN); Heng Wang, Changping District (CN); Xiao Ling Chen, Changping District (CN); Xi Bo Zhu, Haidian Dist (CN)

(21) Appl. No.: 19/060,701

(22) Filed: Feb. 23, 2025

(30) Foreign Application Priority Data
Apr. 4, 2024 (DE) 102024109444.3

(51) Int. Cl. G06F 21/62

(52) U.S. Cl. CPC G06F 21/62; G06F 2221/2103; G06F 2221/2113

(57) ABSTRACT

Controlling resource access requests in a containerized platform includes receiving a request to access a resource associated with a containerized platform. A set of authorization plugins is determined based on the request. A request relay model is applied to the request. The request is transmitted to each authorization plugin of the set of authorization plugins based on the application of the request relay model to the request. A response of a set of responses is determined based on the transmission of the request to an authorization plugin of the set of authorization plugins. A response analyzer model is applied to the set of responses. The access to the resource associated with the containerized platform is controlled based on a set of security levels and the application of the response analyzer model to the set of responses.

### BACKGROUND

The disclosure relates to containerized platforms and more particularly, to resource access requests in containerized platforms.

In recent years, there has been a significant shift from traditional monolithic applications, which typically operate on virtual or physical servers, to microservices architectures that leverage containerization technologies. Microservices architecture allows applications to be divided into smaller, independent services that can be developed, deployed, and scaled autonomously. Containerization platforms have become vital tools in this transformation, enabling developers to package applications and dependencies into isolated environments known as container images. These container images ensure consistent application performance across various computing environments, effectively addressing the challenges associated with dependency management and environment configuration.

Though containerized technology provides an isolated environment, the containerized technology is prone to vulnerabilities. The containerized technology relies on shared operating system resources, which significantly increases security risks with the utilization of the containerized technology. Common vulnerabilities include misconfigurations, insecure container images, and inadequate isolation between containers, which can lead to unauthorized access and data breaches. Additionally, the dynamic nature of containerized environments can pose a challenge to maintain visibility and control over security configurations, leading to potential threats for organizations such as data breaches. Therefore, identifying and mitigating these vulnerabilities is critical for maintaining the integrity of containerized applications.

### SUMMARY

In various embodiments of the disclosure, a computer-implemented method for controlling resource access requests in a containerized platform is described. The computer-implemented method includes receiving, by a computer, a request to access a resource associated with a containerized platform. The computer-implemented method further includes determining, by the computer, a set of authorization plugins based on the request. The computer-implemented method further includes applying, by the computer, a request relay model to the request. The computer-implemented method further includes transmitting, by the computer, the request to each authorization plugin of the set of authorization plugins based on the application of the request relay model to the request. The computer-implemented method further includes determining, by the computer, a response of a set of responses based on the transmission of the request to an authorization plugin of the set of authorization plugins. Each response of the set of responses is associated with the request. The computer-implemented method further includes applying, by the computer, a response analyzer model to the set of responses. The computer-implemented method further includes controlling, by the computer, the access to the resource associated with the containerized platform based on a set of security levels and the application of the response analyzer model to the set of responses.

In various embodiments of the disclosure, a computer system for controlling resource access requests in a containerized platform is described. The computer system includes a processor set, one or more computer-readable storage media, and program instructions stored on the one or more computer-readable storage media. The program instructions are executable by the processor set and cause the processor set to receive a request to access a resource associated with a containerized platform. The program instructions further cause the processor set to determine a set of parameters associated with the request. The set of parameters includes at least one of a type of the request, a source of the request, or a resource type associated with the request. The program instructions further cause the processor set to determine a set of authorization plugins based on the set of parameters. The program instructions further cause the processor set to apply a request relay model to the request. The program instructions further cause the processor set to transmit the request to each authorization plugin of the set of authorization plugins based on the application of the request relay model to the request. The program instructions further cause the processor set to determine a response of a set of responses based on the transmission of the request to an authorization plugin of the set of authorization plugins. Each response of the set of responses is associated with the request. The program instructions further cause the processor set to apply a response analyzer model to the set of responses. The program instructions further cause the processor set to control the access to the resource associated with the containerized platform based on a set of security levels and the application of the response analyzer model to the set of responses.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for controlling resource access requests in a containerized platform, in accordance with an embodiment of the disclosure;

FIG. 2 is a diagram that illustrates an environment for controlling the resource access requests in the containerized platform, in accordance with an embodiment of the disclosure;

FIG. 3 is a diagram that illustrates a first set of exemplary operations for controlling the resource access requests in the containerized platform, in accordance with an embodiment of the disclosure;

FIG. 4 is a diagram that illustrates a second set of exemplary operations for controlling the resource access requests in the containerized platform, in accordance with an embodiment of the disclosure;

FIG. 5 is a diagram that illustrates exemplary operations for generating analysis data based on application of a response analyzer model to a set of responses, in accordance with an embodiment of the disclosure;

FIG. 6 is a diagram that illustrates exemplary operations for determining one or more authorization plugins associated with an anomaly in determination of responses, in accordance with an embodiment of the disclosure;

FIG. 7 is a diagram that illustrates a flowchart of a first exemplary method for controlling the resource access requests in the containerized platform, in accordance with an embodiment of the disclosure; and

FIG. 8 is a diagram that illustrates a flowchart of a second exemplary method for controlling the resource access requests in the containerized platform, in accordance with an embodiment of the disclosure.

### DETAILED DESCRIPTION

In recent years, there has been a significant shift from traditional monolithic applications, which typically operate on virtual or physical servers, to microservices architectures that leverage containerization technologies. This evolution is driven by increasing demand for enhanced flexibility, scalability, and efficiency in software development processes. Microservices architecture allows applications to be divided into smaller, independent services that can be developed, deployed, and scaled autonomously. Containerization platforms have become vital tools in this transformation, enabling developers to package applications and dependencies into isolated environments known as container images. These container images ensure consistent application performance across various computing environments, effectively addressing the challenges associated with dependency management and environment configuration. Moreover, the utilization of microservices and containerization promotes a more flexible development environment for concurrent utilization of different services without the risk of impacting the different services. Furthermore, the utilization of containers enhances the portability of applications, enabling the applications to run seamlessly across various environments, from local development machines to cloud-based infrastructures. This portability is particularly beneficial in hybrid cloud scenarios, where organizations can leverage both on-premises and cloud resources to meet the computing needs.

Though containerized technology provides an isolated environment, the containerized technology is prone to vulnerabilities. The containerized technology relies on shared operating system resources, which significantly increases security risks with the utilization of the containerized technology. Common vulnerabilities include misconfigurations, insecure container images, and inadequate isolation between containers, which can lead to unauthorized access and data breaches. Additionally, the dynamic nature of containerized environments can pose challenges to maintain visibility and control over security configurations, leading to potential threats for organizations such as data breaches. Therefore, identifying and mitigating these vulnerabilities is critical for maintaining the integrity of containerized applications.

The challenges faced by containerized platforms can significantly impact the security and integrity of applications. One of the primary concerns is the dependency on shared operating system resources, which increases the probability of attacks for potential vulnerabilities. Additionally, the dynamic nature of containerized environments complicates the maintenance of consistent security configurations, as containers are frequently created, destroyed, and redeployed.

While containerized technologies offer some built-in security features, such as user namespaces and image signing, the provided measures may not be sufficient to address the complex security challenges faced by the organizations. The utilization of security tools or custom solutions to enhance container security, often leads to inconsistencies in security practices and potential gaps in protection. The fragmented nature of security solutions in the containerized technologies stresses a need for more robust and integrated security frameworks that can effectively safeguard the containerized platforms.

The disclosed system utilizes a plurality of authorization plugins from a plurality of sources. The plurality of authorization plugins mitigates the risks associated with vulnerabilities in one or more authorization plugins of the plurality of authorization plugins. The plurality of authorization plugins generates a plurality of responses based on the received request. The disclosed system analyzes the plurality of responses by comparing each response of the plurality of responses with a result. The result indicates an accurate response to the request. The disclosed system identifies vulnerabilities in one or more authorization plugins of the plurality of authorization plugins which are associated with an anomaly in generating the response associated with the request. The anomaly in generating the response is indicative of generating a response different from the result. The disclosed system identifies vulnerabilities in the one or more authorization plugins that generate responses different from the result. The vulnerability in the one or more authorization plugins is utilized by the disclosed system to identify the one or more authorization plugins that may pose a security threat to the disclosed system. Therefore, the disclosed system identifies the vulnerabilities in the one or more authorization plugins to increase the overall security of the computing environment of the disclosed system.

The disclosed system utilizes a request relay model for systematically forwarding requests to the plurality of authorization plugins. The request is indicative of access to the resource associated with the containerized platform. The systematic forwarding of the request improves the decision-making in forwarding the request to the plurality of authorization plugins. The disclosed system utilizes the request relay model and establishes a structured workflow to handle forwarding of the request to the plurality of authorization plugins. The structured workflow decreases delays in processing time to forward the request to the plurality of authorization plugins. The disclosed system utilizes the request relay model to reduce errors in forwarding the request by using the structured workflow to forward the request to the plurality of authorization plugins.

The disclosed system utilizes a response analyzer model. The disclosed system analyzes the plurality of responses associated with the plurality of authorization plugins. The disclosed system utilizes the response analyzer model to identify vulnerabilities in the plurality of responses associated with the plurality of the authorization plugins based on the analysis. The disclosed system compares each response of the plurality of responses with the result. The disclosed system identifies the one or more responses that are different from the result. The disclosed system identifies vulnerabilities in the one or more authorization plugins associated with the one or more responses. The vulnerabilities indicate potential security threats present within the computing environment of the disclosed system. The disclosed system further rectifies the vulnerability by eliminating a vulnerable authorization plugin of the one or more authorization plugins from the plurality of authorization plugins.

In various embodiments of the disclosure, a computer-implemented method for controlling resource access requests in a containerized platform is described. The computer-implemented method includes receiving, by a computer, a request to access a resource associated with a containerized platform. The computer-implemented method further includes determining, by the computer, a set of authorization plugins based on the request. The computer-implemented method further includes applying, by the computer, a request relay model to the request. The computer-implemented method further includes transmitting, by the computer, the request to each authorization plugin of the set of authorization plugins based on the application of the request relay model to the request. The computer-implemented method further includes determining, by the computer, a response of a set of responses based on the transmission of the request to an authorization plugin of the set of authorization plugins. Each response of the set of responses is associated with the request. The computer-implemented method further includes applying, by the computer, a response analyzer model to the set of responses. The computer-implemented method further includes controlling, by the computer, the access to the resource associated with the containerized platform based on a set of security levels and the application of the response analyzer model to the set of responses.

In various embodiments of the disclosure, the computer implemented method further includes determining, by the computer, a set of parameters associated with the request. The set of parameters includes at least one of a type of the request, a source of the request, or a resource type associated with the request. The computer implemented method further includes determining, by the computer, the set of authorization plugins based on the set of parameters.

In various embodiments of the disclosure, the application of the response analyzer model to the set of responses by the computer implemented method includes determining, by the computer, a set of values associated with the set of responses. The application of the response analyzer model to the set of responses by the computer implemented method further includes identifying, by the computer, a subset of responses from the set of responses based on the set of values. The application of the response analyzer model to the set of responses by the computer implemented method further includes calculating, by the computer, a score associated with the set of responses based on a count of the set of authorization plugins and a count of the subset of responses. The application of the response analyzer model to the set of responses by the computer implemented method further includes comparing, by the computer, the score, and a security threshold value. The security threshold value is associated with a security level of the set of security levels.

In various embodiments of the disclosure, the computer implemented method further includes determining, by the computer, the score is greater than the security threshold value based on the comparison of the score with the security threshold value. The computer implemented method further includes controlling, by the computer, the access to the resource associated with the containerized platform based on the determination of the score being greater than the security threshold value. The controlling of the access to the resource corresponds to a grant of the access to the resource associated with the containerized platform.

In various embodiments of the disclosure, the computer implemented method further includes determining, by the computer, the score is less than the security threshold value based on the comparison of the score with the security threshold value. The computer implemented method further includes controlling, by the computer, the access to the resource associated with the containerized platform based on the determination of the score being less than the security threshold value. The controlling of the access to the resource corresponds to a denial of the access to the resource associated with the containerized platform.

In various embodiments of the disclosure, the application of the response analyzer model to the set of responses by the computer implemented method includes analyzing, by the computer, the set of responses. The application of the response analyzer model to the set of responses by the computer implemented method further includes generating, by the computer, analysis data based on the analysis of the set of responses. The application of the response analyzer model to the set of responses by the computer implemented method further includes outputting, by the computer, the analysis data including the set of responses and an access result indicative of one of a grant of the access to the resource or a denial of the access to the resource.

In various embodiments of the disclosure, the computer implemented method further includes comparing, by the computer, each response of the set of responses with the access result based on the analysis data. The computer implemented method further includes identifying, by the computer, one or more responses from the set of responses based on the comparison of each response of the set of responses with the access result. Each response of the one or more responses is different from the access result. The computer implemented method further includes identifying, by the computer, one or more authorization plugins of the set of authorization plugins based on the one or more responses. The one or more responses are associated with the one or more authorization plugins. The computer implemented method further includes outputting, by the computer, the one or more authorization plugins.

In various embodiments of the disclosure, a computer system for controlling resource access requests in a containerized platform is described. The computer system includes a processor set, one or more computer-readable storage media, and program instructions stored on the one or more computer-readable storage media. The program instructions are executable by the processor set and cause the processor set to receive a request to access a resource associated with a containerized platform. The program instructions further cause the processor set to determine a set of parameters associated with the request. The set of parameters includes at least one of a type of the request, a source of the request, or a resource type associated with the request. The program instructions further cause the processor set to determine a set of authorization plugins based on the set of parameters. The program instructions further cause the processor set to apply a request relay model to the request. The program instructions further cause the processor set to transmit the request to each authorization plugin of the set of authorization plugins based on the application of the request relay model to the request. The program instructions further cause the processor set to determine a response of a set of responses based on the transmission of the request to an authorization plugin of the set of authorization plugins. Each response of the set of responses is associated with the request. The program instructions further cause the processor set to apply a response analyzer model to the set of responses. The program instructions further cause the processor set to control the access to the resource associated with the containerized platform based on a set of security levels and the application of the response analyzer model to the set of responses.

In various embodiments of the disclosure, the application of the response analyzer model to the set of responses by the program instructions further causes the processor set to determine a set of values associated with the set of responses. The application of the response analyzer model to the set of responses by the program instructions further causes the processor set to identify a subset of responses from the set of responses based on the set of values. The application of the response analyzer model to the set of responses by the program instructions further causes the processor set to calculate a score associated with the set of responses based on a count of the set of authorization plugins and a count of the subset of responses. The application of the response analyzer model to the set of responses by the program instructions further causes the processor set to compare the score and a security threshold value. The security threshold value is associated with a security level of the set of security levels.

In various embodiments of the disclosure, the program instructions further cause the processor set to determine the score is greater than the security threshold value based on the comparison of the score with the security threshold value. The program instructions further cause the processor set to control the access to the resource associated with the containerized platform based on the determination of the score being greater than the security threshold value. The control of the access to the resource corresponds to a grant of the access to the resource associated with the containerized platform.

In various embodiments of the disclosure, the program instructions further cause the processor set to determine the score is less than the security threshold value based on the comparison of the score with the security threshold value. The program instructions further cause the processor set to control the access to the resource associated with the containerized platform based on the determination of the score being less than the security threshold value. The control of the access to the resource corresponds to a denial of the access to the resource associated with the containerized platform.

In various embodiments of the disclosure, the application of the response analyzer model to the set of responses by the program instructions further causes the processor set to analyze the set of responses. The application of the response analyzer model to the set of responses by the program instructions further causes the processor set to generate analysis data based on the analysis of the set of responses. The application of the response analyzer model to the set of responses by the program instructions further causes the processor set to output the analysis data. The analysis data includes the set of responses and an access result indicative of one of a grant of the access to the resource or a denial of the access to the resource.

In various embodiments of the disclosure, the program instructions further cause the processor set to compare each response of the set of responses with the access result based on the generated analysis data. The program instructions further cause the processor set to identify one or more responses from the set of responses based on the comparison of each response of the set of responses with the access result. Each response of the one or more responses is different from the access result. The program instructions further cause the processor set to identify one or more authorization plugins of the set of authorization plugins based on the one or more responses. The one or more responses are associated with the one or more authorization plugins. The program instructions further cause the processor set to output the one or more authorization plugins.

In various embodiments of the disclosure, a computer-program product to control an access to a resource associated with a containerized platform is described. The computer program product includes one or more computer-readable storage media and program instructions stored in the one or more computer-readable storage media to perform operations that include receiving a request to access the resource associated with the containerized platform. The operations further include determining a set of authorization plugins based on the request. The operations further include applying a request relay model to the request. The operations further include transmitting the request to each authorization plugin of the set of authorization plugins based on the application of the request relay model to the request. The operations further include determining a response of a set of responses based on the transmission of the request to an authorization plugin of the set of authorization plugins. Each response of the set of responses is associated with the request. The operations further include applying a response analyzer model to the set of responses. The operations further include controlling the access to the resource associated with the containerized platform based on a set of security levels and the application of the response analyzer model to the set of responses.

In various embodiments of the disclosure, the operations further include determining a set of parameters associated with the request. The set of parameters includes at least one of a type of the request, a source of the request, or a resource type associated with the request. The operations further include determining the set of authorization plugins based on the set of parameters.

In various embodiments of the disclosure, the application of the response analyzer model to the set of responses by the operations further includes determining a set of values associated with the set of responses. The application of the response analyzer model to the set of responses by the operations further includes identifying a subset of responses from the set of responses based on the set of values. The application of the response analyzer model to the set of responses by the operations further includes calculating a score associated with the set of responses based on the set of authorization plugins and the subset of responses. The application of the response analyzer model to the set of responses by the operations further includes comparing the score and a security threshold value. The security threshold value is associated with a security level of the set of security levels.

In various embodiments of the disclosure, the operations further include determining the score is greater than the security threshold value based on the comparison of the score with the security threshold value. The operations further include controlling the access to the resource associated with the containerized platform based on the determination of the score being greater than the security threshold value. The controlling of the access to the resource corresponds to a grant of the access to the resource associated with the containerized platform.

In various embodiments of the disclosure, the operations further include determining the score is less than the security threshold value based on the comparison of the score with the security threshold value. The operations further include controlling the access to the resource associated with the containerized platform based on the determination of the score being less than the security threshold value. The controlling of the access to the resource corresponds to a denial of the access to the resource associated with the containerized platform.

In various embodiments of the disclosure, the application of the response analyzer model to the set of responses by the operations further includes analyzing the set of responses. The application of the response analyzer model to the set of responses by the operations further includes generating analysis data based on the analysis of the set of responses. The application of the response analyzer model to the set of responses by the operations further includes outputting the analysis data including the set of responses and an access result indicative of one of a grant of the access to the resource or a denial of the access to the resource.

In various embodiments of the disclosure, the operations further include comparing each response of the set of responses with the access result based on the generated analysis data. The operations further include identifying one or more responses from the set of responses based on the comparison of each response of the set of responses with the access result. Each response of the one or more responses is different from the access result. The operations further include identifying one or more authorization plugins of the set of authorization plugins based on the one or more responses. The one or more responses are associated with the one or more authorization plugins. The operations further include outputting the one or more authorization plugins.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while the data is stored.

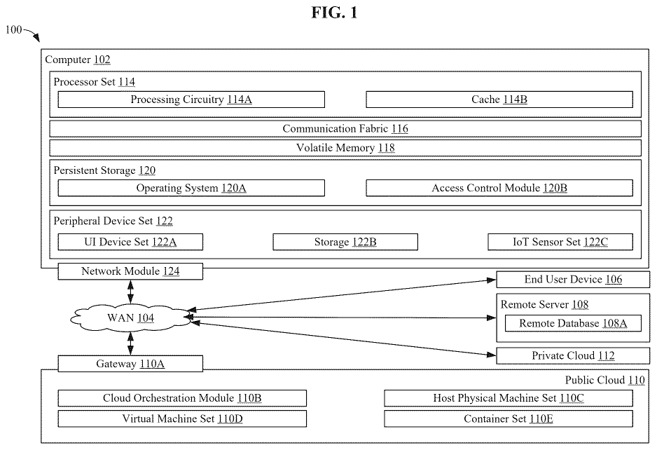

FIG. 1 is a diagram that illustrates a computing environment for controlling resource access requests in a containerized platform, in accordance with an embodiment of the disclosure. With reference to FIG. 1, there is shown a computing environment 100 that contains an example of an environment for the execution of at least some of the computer code involved in performing the disclosed methods, such as an access control module 120B. In addition to the access control module 120B, the computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the access control module 120B, as identified above), a peripheral device set 122 (including a user interface (UI) device set 122A, a storage 122B, and an Internet of Things (IOT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that is configured for running a program, accessing a network or querying a database, such as the remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. In an embodiment of the disclosure, the computer 102 is located in a cloud, even though the computer 102 is not shown in a cloud in FIG. 1. The computer 102 is not vital to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the access control module 120B in persistent storage 120.

The communication fabric 116 is the signal conduction path that allows the various components of the computer 102 to communicate with the aforementioned components of the computer 102. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not vital unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the access control module 120B typically includes at least some of the computer code involved in performing the disclosed methods.

The peripheral device set 122 includes the set of peripheral devices of the computer 102. Data communication connections between the peripheral devices and the various components of the computer 102 are implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, the storage 122B may take the form of a quantum computing storage device for storing data in the form of qubits. In embodiments of the disclosure where the computer 102 is vital to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows the computer 102 to communicate with various computers through the WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to the computer 102 from an external computer or external storage device through a network adapter card or network interface included in the network module 124.

The WAN 104 is any wide area network (for example, the internet) that communicates computer data over non-local distances by any technology for communicating computer data, now known or to be developed in the future. In some embodiments of the disclosure, the WAN 104 is replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present recommendations to an end user. In some embodiments of the disclosure, the EUD 106 may be a client device, such as a thin client, heavy client, mainframe computer, desktop computer, and so on.

The remote server 108 is any computer system that serves at least some data and/or functionality to the computer 102. The remote server 108 is controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. The VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows the public cloud 110 to communicate through the WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in the isolated user-space instances. A computer program running on an ordinary operating system can utilize available resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of distinct types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

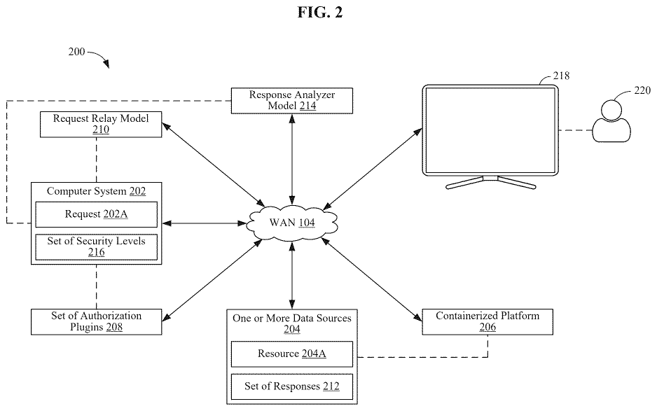

FIG. 2 is a diagram that illustrates an environment for controlling resource access requests in the containerized platform, in accordance with an embodiment of the disclosure. FIG. 2 is explained in conjunction with elements from FIG. 1. With reference to FIG. 2, there is shown a diagram of a network environment 200. The network environment 200 includes a computer system 202, one or more data sources 204, a containerized platform 206, and a set of authorization plugins 208. The network environment 200 further includes a request relay model 210, a response analyzer model 214, and a user device 218. The computer system 202 includes a request 202A and a set of security levels 216. The one or more data sources 204 include a resource 204A and a set of responses 212. The user device 218 is associated with a user 220. The network environment 200 further includes the WAN 104 of FIG. 1. In an embodiment of the disclosure, the user device 218 is an exemplary embodiment of the EUD 106. Similarly, the computer system 202 is an exemplary embodiment of the computer 102 in FIG. 1.

The computer system 202 includes suitable logic, circuitry, and/or interfaces for controlling resource access requests in the containerized platform, in accordance with an embodiment of the disclosure. The computer system 202 receives the request 202A to access the resource 204A associated with the containerized platform 206. The computer system 202 further determines the set of authorization plugins 208 based on the request 202A. The computer system 202 further applies the request relay model 210 to the request 202A. The computer system 202 further transmits the request 202A to each authorization plugin of the set of authorization plugins 208 based on the application of the request relay model 210 to the request 202A. The computer system 202 further determines a response of the set of responses 212 based on the transmission of the request 202A to an authorization plugin of the set of authorization plugins 208. Each response of the set of responses 212 is associated with the request 202A. The computer system 202 further applies the response analyzer model 214 to the set of responses 212. The computer system 202 further controls the access to the resource 204A associated with the containerized platform 206 based on the set of security levels 216 and the application of the response analyzer model 214 to the set of responses 212.

Examples of the computer system 202 include but are not limited to, a cloud-based service, a cloud-based application, a cloud-based platform, a remote server-based service, a remote server-based application, a remote server-based platform, or a virtual computing system.

Each data source of the one or more data sources 204 corresponds to an organized collection of data that may be stored and accessed electronically from the computer system 202. Each of the one or more data sources 204 may be designed to manage, store, retrieve, and update data efficiently. In an exemplary implementation, each data source of the one or more data sources 204 may correspond to a database. In such an implementation, the structure of the database corresponding to each data source of the one or more data sources 204 typically involves tables, records, and fields that can be managed through various database management systems (DBMS). Examples of each data source of the one or more data sources 204 may include but are not limited to, a relational database, a Non-Structured Query Language (SQL) database, a hierarchical database, a network database, a transactional database, a data warehouse, and a distributed database.

In an embodiment of the disclosure, each data source of the one or more data sources 204 stores the resource 204A. The resource 204A is a computational entity that is allocated, managed, and utilized by the containerized platform 206 to perform a plurality of operations associated with the containerized platform 206. The resource 204A includes a plurality of components. The plurality of components includes by way of example, and not by limitation, computing resources, memory resources, and disk resources.

In an embodiment of the disclosure, each data source of the one or more data sources 204 stores the set of responses 212 associated with the set of authorization plugins 208. Each response of the set of responses 212 is determined based on the request 202A authorized by the corresponding authorization plugin of the set of authorization plugins 208.

The containerized platform 206 includes suitable logic, code, and circuitry that is configured to facilitate the creation, deployment, and management of containerized images of applications within lightweight, portable containers. The containerized platform 206 ensures that applications, along with the dependencies, are encapsulated in a manner that guarantees consistent performance across various computing environments, thereby addressing compatibility issues that may arise during the software development lifecycle. The architecture of the containerized platform 206 allows for efficient resource utilization, rapid deployment, and seamless scalability, enabling organizations to improve the operational workflows and enhance productivity.

In an embodiment of the disclosure, the containerized platform 206 is implemented as a plurality of distributed cloud-based resources by use of several technologies that are well known to those ordinarily skilled in the art. A person with ordinary skill in the art will understand that the scope of the disclosure may not be limited to the implementation of the containerized platform 206 and the computer system 202 as two separate entities. In certain embodiments, the functionalities of the containerized platform 206 can be incorporated in its entirety or at least partially in the computer system 202, without a departure from the scope of the disclosure.

Each authorization plugin of the set of authorization plugins 208 is indicative of a software component that integrates with an application or system to enforce access control policies and manage user permissions for various resources and operations. Each authorization plugin of the set of authorization plugins 208 evaluates incoming requests (e.g., the request 202A) against defined authorization rules, determining whether a user or service has the vital rights to perform specific actions, such as creating, modifying, or deleting resources (e.g., the resource 204A). In an embodiment of the disclosure, each authorization plugin of the set of authorization plugins 208 authorizes the request 202A. Upon the authorization of the request 202A by each authorization plugin of the set of authorization plugins 208, the computer system 202 determines the set of responses 212.

In an embodiment of the disclosure, the set of authorization plugins 208 includes three or more authorization plugins associated with a plurality of sources. The plurality of sources includes, by way of example, and not by limitation, open-source repositories, commercial authorization service providers, custom-built authorization plugins, and container orchestration platforms.

The request relay model 210 is a software component designed to facilitate processing and forwarding of requests to target destinations such as, by way of example, and not by limitation, web servers, application servers, APIs, databases, and containerized platforms. The request relay model 210 serves as an intermediary that ensures seamless communication between the target destinations (e.g., the set of authorization plugins 208), improving the flow of data and enhancing overall system performance.

The request relay model 210 includes primary functions such as, but not limited to, request forwarding, load balancing, caching, logging, and error handling. The request forwarding involves receiving requests and directing the requests to a designated target destination based on defined routing rules. The defined routing rules refer to algorithms that dictate how incoming requests (e.g., the request 202A) are analyzed and directed to specific target destinations (or the set of authorization plugins 208) within a network. The load balancing distributes incoming requests (e.g., the request 202A) to the target destinations (e.g., the set of authorization plugins 208) to improve resource utilization and improve response time. The caching temporarily stores responses (e.g., the set of responses 212) to reduce latency for frequently accessed data. The logging refers to a systematic process of recording events and transactions generated by a system (e.g., the request relay model 210) in a structured format. The logging is stored in log files or databases (e.g., the one or more data sources 204). The error handling is a systematic approach employed by a system (e.g., the request relay model 210) to detect, manage, and respond to errors or exceptions that occur during the execution of operations (e.g., forwarding of the request 202A).

The request relay model 210 is a gateway for routing requests among a plurality of microservices, ensuring efficient communication between the computer system 202 and the set of authorization plugins 208 for forwarding the request 202A to each authorization plugin of the set of authorization plugins 208. The request relay model 210 is utilized as an API gateway, providing a single-entry point for API requests, and managing traffic while enforcing security policies. The request relay model 210 is utilized in web applications by relaying requests from client-side applications to server-side resources, handling tasks such as session management and data retrieval. In an embodiment of the disclosure, the computer system 202 applies the request relay model 210 to the request 202A. The computer system 202 transmits the request 202A to each authorization plugin of the set of authorization plugins 208 based on the application of the request relay model 210 to the request 202A.

Each response of the set of responses 212 is indicative of a result generated by the corresponding authorization plugin of the set of authorization plugins 208. In an embodiment of the disclosure, the result is indicative of a grant of the access to the resource 204A associated with the containerized platform 206. In an alternate embodiment of the disclosure, the result is indicative of a denial of the access to the resource 204A associated with the containerized platform 206.

The response analyzer model 214 is configured to evaluate and interpret the set of responses 212 generated by the set of authorization plugins 208 in response to the request 202A. The response analyzer model 214 systematically analyzes various attributes of each response, such as the type of the request 202A, the source of the request 202A, or the resource type associated with the request 202A. Upon the analysis, the response analyzer model 214 determines a result indicative of a denial or a grant of access to resources (e.g., the resource 204A) associated with the incoming requests (e.g., the request 202A).

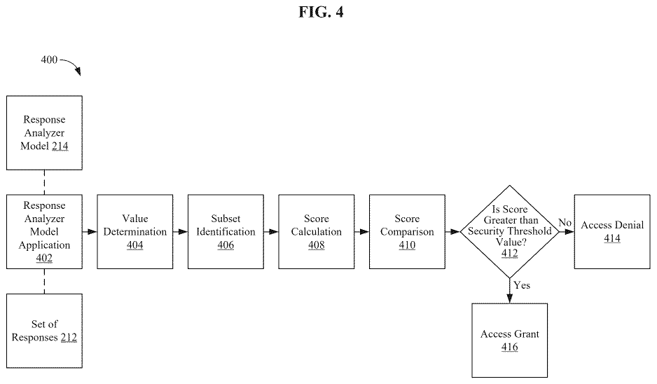

In an embodiment of the disclosure, the response analyzer model 214 determines a set of values associated with the set of responses 212. The response analyzer model 214 further identifies a subset of responses from the set of responses 212 based on the set of values. The response analyzer model 214 further calculates a score associated with the set of responses 212 based on a count of the set of authorization plugins 208 and a count of the subset of responses. The response analyzer model 214 further compares the score with a security threshold value associated with a security level of the set of security levels 216. The response analyzer model 214 determines a comparison result of the score and the security threshold value. The computer system 202 utilizes the comparison result to control the access to the resource 204A associated with the containerized platform 206. Details about applying the response analyzer model 214 to the set of responses 212 to determine the comparison result are provided in FIG. 4, and its corresponding description.

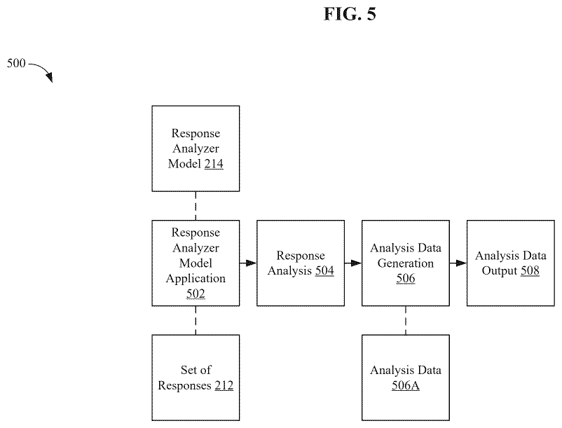

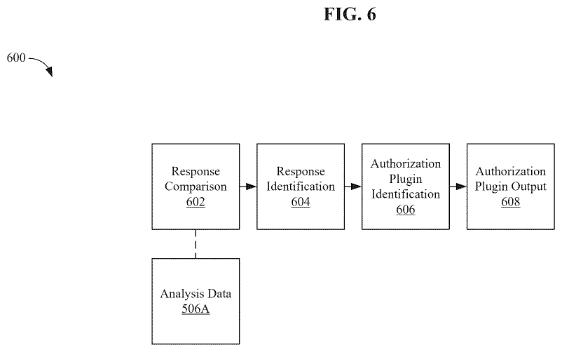

In an alternate embodiment of the disclosure, the response analyzer model 214 generates analysis data based on the set of responses 212. The analysis data includes the set of responses 212 and an access result. The access result is indicative of a result associated with the access to the resource 204A. In an embodiment of the disclosure, the access result is indicative of the grant of the access to the resource 204A. In an alternate embodiment, the access result is indicative of the denial of the access to the resource 204A. The computer system 202 utilizes the analysis data to determine one or more authorization plugins of the set of authorization plugins 208. Details about the analysis data are provided, in FIG. 5 and its corresponding description. Details about applying the response analyzer model 214 to the set of responses 212 to generate the analysis data are provided, in FIG. 5 and its corresponding description. Details about the determination of the one or more authorization plugins are provided, in FIG. 6 and its corresponding description.

Each security level of the set of security levels 216 is indicative of security that is used by the computer system 202 for granting or restricting (or denial) access to resources (e.g., the resource 204A), information, or systems. Each security level of the set of security levels 216 is associated with a threshold that defines a minimum criteria that must be met for access to be permitted. Each security level of the set of security levels 216 is determined, by way of example, and not by limitation, by evaluating the sensitivity of the data contained within a container associated with the containerized platform 206, the potential impact of unauthorized access or breaches, and the effectiveness of existing security controls implemented within the containerized platform 206. The container is a lightweight, portable, and self-sufficient unit of software that encapsulates an application and its dependencies, including libraries, configuration files, and runtime environment, allowing the container to run consistently across different computing environments. The data sensitivity refers to a classification of the data contained in the container based on the confidentiality of the data contained in the container and the potential impact of unauthorized access on the data contained in the container. By way of example, and not by limitation, the container data includes configuration files, libraries, database files, and user data. The configuration files are structured text files that contain settings and parameters that are used to define the behavior, properties, and environment of software applications or systems, enabling customization and control over the operation. The libraries are collections of compiled code, functions, and routines that provide reusable software components and APIs, enabling developers to perform specific tasks or implement functionalities without having to write code from scratch. The database files are structured files that store organized data in a format that allows for efficient retrieval, manipulation, and management of information, typically using a database management system (DBMS) to facilitate operations such as querying, updating, and transaction processing.

The user device 218 includes suitable logic, circuitry, and/or interfaces that are configured to execute one or more tasks within the network environment 200. The user device 218 performs the one or more tasks such as receiving data, processing the data, and transmitting the data. In an embodiment of the disclosure, the computer system 202 receives the set of responses 212 from the user device 218.

In an alternate embodiment of the disclosure, the computer system 202 renders a message on the user device 218. The message is associated with the control of the access to the resource 204A. By way of example, and not by limitation, the message may be “The control of the access to the resource is granted”. Examples of the user device 218 include one but are not limited to, a computer workstation, a laptop, a smartphone, a cellular phone, a mobile phone, a consumer electronic (CE) device, an Internet of Things (IoT) device, a computing device, a mainframe machine, a server, or the like.

In operation, the computer system 202 receives the request 202A to access the resource 204A associated with the containerized platform 206. By way of example, and not by limitation, the computer system 202 receives the request 202A indicative of access to the container associated with the containerized platform 206. The computer system 202 further determines a set of parameters associated with the request 202A. The set of parameters includes at least one of a type of the request 202A, a source of the request 202A, or a resource type associated with the request 202A.

In an embodiment of the disclosure, the computer system 202 determines the set of authorization plugins 208 based on the set of parameters associated with the request 202A. The computer system 202 applies the request relay model 210 to the request 202A. The request relay model 210 is the software component designed to facilitate processing and forwarding of requests (e.g., the request 202A) to target destinations such as, by way of example, and not by limitation, the set of authorization plugins 208. The computer system 202 further transmits the request 202A to each authorization plugin of the set of authorization plugins 208 based on the application of the request relay model 210 to the request 202A. In an embodiment of the disclosure, the request relay model 210 simultaneously transmits the request 202A to each authorization plugin of the set of authorization plugins 208.

In an alternate embodiment of the disclosure, the request relay model 210 sequentially transmits the request 202A to each authorization plugin of the set of authorization plugins 208. By way of example, and not by limitation, upon the generation of a first response of the set of responses 212 by a first authorization plugin of the set of authorization plugins 208, the request relay model 210 transmits the request 202A to a second authorization plugin of the set of authorization plugin 208.

The computer system 202 further determines the response of the set of responses 212 based on the transmission of the request 202A to the authorization plugin of the set of authorization plugins 208. Each response of the set of responses 212 is associated with the request 202A. By way of example, and not by limitation, the computer system 202 determines the first response of the set of responses 212 based on the transmission of the request 202A to the first authorization plugin of the set of authorization plugins 208.

The computer system 202 further applies the response analyzer model 214 to the set of responses 212. The response analyzer model 214 is the tool designed to evaluate and ensure coherence and reliability of the responses generated by the automated systems such as, by way of example, and not by limitation, the set of authorization plugins 208.

In an embodiment of the disclosure, the response analyzer model 214 determines the set of values associated with the set of responses 212. The response analyzer model 214 further identifies the subset of responses from the set of responses 212 based on the set of values. The response analyzer model 214 further calculates the score associated with the set of responses 212 based on the count of the set of authorization plugins 208 and the count of the subset of responses. The response analyzer model 214 further compares the score with the security threshold value. The security threshold value is associated with the security level of the set of security levels 216. The security level is indicative of the security that is used by the computer system 202 for granting or restricting (or denial) access to the resource 204A. The response analyzer model 214 determines the comparison result of the score and the security threshold value. The computer system 202 utilizes the comparison result determined by the response analyzer model 214 to control the access to the resource 204A associated with the containerized platform 206. Details about applying the response analyzer model 214 to the set of responses 212 to determine the comparison result are provided in FIG. 4, and its corresponding description.

In an alternate embodiment of the disclosure, the response analyzer model 214 generates the analysis data based on the set of responses 212. The response analyzer model 214 analyzes the set of responses 212 to generate the analysis data. The computer system 202 utilizes the analysis data to determine the one or more authorization plugins of the set of authorization plugins 208. The analysis data includes the set of responses 212 and the access result. The access result is indicative of one of the grant of the access to the resource 204A or the denial of the access to the resource 204A. Details about the analysis data are provided, in FIG. 5 and its corresponding description.

The computer system 202 compares each response of the set of responses 212 with the access result based on the analysis data. The computer system 202 further identifies one or more responses from the set of responses 212 based on the comparison of each response of the set of responses 212 with the access result. The comparison indicates that each response of the one or more responses is different from the access result. By way of example, and not by limitation, the access result is indicative of the grant of the access to the resource 204A associated with the containerized platform 206. Each response of the one or more responses is indicative of the denial of the access to the resource 204A associated with the containerized platform 206.

The computer system 202 further identifies one or more authorization plugins of the set of authorization plugins 208 based on the one or more responses. The one or more responses are associated with the one or more authorization plugins. Specifically, the one or more responses are generated by the one or more authorization plugins.

Details about applying the response analyzer model 214 to the set of responses 212 to generate the analysis data are provided, in FIG. 5 and its corresponding description. Details about the determination of the one or more authorization plugins are provided, in FIG. 6 and its corresponding description.

To this end, the computer system 202 controls the access to the resource 204A associated with the containerized platform 206 based on the set of security levels and the application of the response analyzer model 214 to the set of responses 212. By way of example, and not by limitation, the computer system 202 controls the access to the resource 204A associated with the containerized platform 206 based on the security level of the set of security levels 216 and the comparison result determined by the application of the response analyzer model 214 to the set of responses 212. For example, the control of the access to the resource 204A corresponds to the denial of the access to the resource 204A associated with the containerized platform 206.

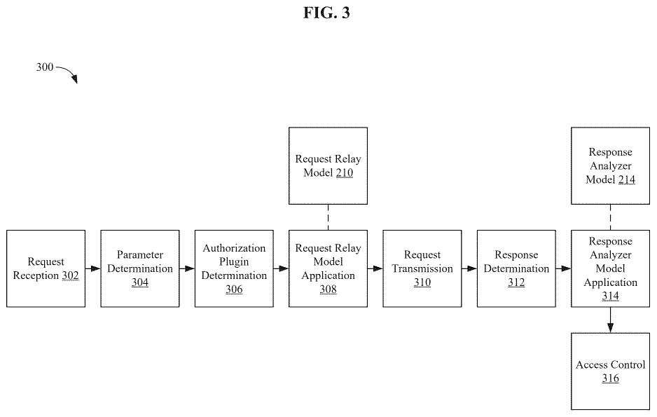

FIG. 3 is a diagram that illustrates a first set of exemplary operations for controlling resource access requests in the containerized platform, in accordance with an embodiment of the disclosure. FIG. 3 is explained in conjunction with elements from FIG. 1 and FIG. 2. With reference to FIG. 3, there is shown the block diagram 300 that illustrates the first set of exemplary operations from 302 to 316, as described herein. The first set of exemplary operations illustrated in the block diagram 300 start at 302 and are performed by any computing system, apparatus, or device, such as by the computer 102 of FIG. 1 or by the computer system 202 of FIG. 2. Although illustrated with discrete blocks, the first set of exemplary operations associated with one or more blocks of the block diagram 300 can be divided into additional blocks, combined into fewer blocks, or eliminated, depending on the implementation.

At 302, a request reception operation is executed. In the request reception operation, the computer system 202 receives the request 202A to access the resource 204A associated with the containerized platform 206. By way of example, and not by limitation, the computer system 202 receives the request 202A indicative of the access of the resource 204A. The resource 204A is present within the container associated with the containerized platform 206. For example, the resource 204A is a table that includes user data. The request 202A is an HTTP request that is received by the computer system 202 from a source. The source is, by way of example, and not by limitation, the user 220, an application, or a service associated with the containerized platform 206.

At 304, a parameter determination operation is executed. In the parameter determination operation, the computer system 202 determines the set of parameters associated with the request 202A. In an embodiment of the disclosure, the set of parameters associated with the request 202A includes at least one of the type of the request 202A, the source of the request 202A, and the resource type associated with the request 202A.

The type of the request 202A is indicative of a type of operation associated with the request 202A. The type of the operation associated with the request 202A includes one of, but not limited to, a ‘GET’ operation, a ‘POST’ operation, a ‘PUT’ operation, and a ‘DELETE’ operation. The ‘GET’ operation is indicative of an HTTP method that is utilized to request data from the resource 204A associated with the containerized platform 206. The ‘GET’ operation corresponds to the retrieval of information associated with the resource 204A without modifying the resource 204A. The ‘POST’ operation is indicative of the HTTP method that is utilized to submit data to the resource 204A associated with the containerized platform 206, often resulting in the creation of a new resource or the modification of an existing one. The ‘PUT’ operation is indicative of the HTTP method that is utilized to update or replace the resource 204A associated with the containerized platform 206. The ‘DELETE’ operation is indicative of the HTTP method that is utilized to request the removal of the resource 204A from the containerized platform 206.

The source of the request 202A indicates whether the request 202A is received from one of, by way of example, and not by limitation, the user 220, an application, or a service associated with the containerized platform 206. The service associated with the containerized platform 206 includes, by way of example, and not by limitation, automation, orchestration, and load balancing. The automation is associated with the deployment and management of containers associated with the containerized platform 206. The orchestration is associated with the lifecycle of the containers. The lifecycle of containers refers to a plurality of stages associated with the container from the creation of the container to the termination of the container. The plurality of stages includes, by way of example, and not by limitation, creation of the container, storing the container within the containerized platform 206, instantiation of the container, execution of the container on the containerized platform 206, management of the container, and removal of the container from the containerized platform 206.

The resource type associated with the request 202A is indicative of a category of the resource 204A associated with the containerized platform 206. In an embodiment of the disclosure, the category of the resource 204A includes one of the containers, images, volumes, or networks. The images refer to immutable templates that are used to create the containers. The volumes refer to a storage medium for container data. The container data includes the code of the application associated with the container, frameworks associated with the application, and libraries associated with the application. The networks refer to a communication medium that establishes communication between containers.

Each category of resource 204A is associated with a unique identifier. By way of example, and not by limitation, each container of the containers is associated with a unique container identifier such as, a first container is associated with the unique container identifier ‘Cont_ID1’. By way of example, and not by limitation, each image of the images is associated with a unique image identifier such as, for example, a first image is associated with the unique image identifier ‘Img_ID1’.

At 306, an authorization plugin determination operation is executed. In the authorization plugin determination operation, the computer system 202 determines the set of authorization plugins 208. In an embodiment of the disclosure, the computer system 202 determines the set of authorization plugins 208 based on the set of parameters. In an embodiment of the disclosure, the computer system 202 determines the set of authorization plugins 208 based on the type of the request 202A. In an alternate embodiment of the disclosure, the computer system 202 determines the set of authorization plugins 208 based on the source of the request 202A, or the resource type associated with the request 202A. In an embodiment of the disclosure, the computer system 202 determines the set of authorization plugins 208 based on a combination of at least two of the type of the request 202A, the source of the request 202A, or the resource type associated with the request 202A.

By way of example, and not by limitation, the type of the request 202A is the ‘GET’ operation. The computer system 202 determines the set of authorization plugins 208 based on the type of the request 202A indicative of the ‘GET’ operation. By way of example, and not by limitation, the user 220 sends the request 202A for access to the resource 204A via the user device 218. The computer system 202 determines the set of authorization plugins 208 based on the source of the request 202A corresponding to the user 220. For example, the user 220 sends the request 202A to start a web application associated with the container present within the containerized platform 206. The computer system 202 determines the set of parameters associated with the request 202A. The set of parameters includes the source of the request 202A indicative of the user 220. The user 220 corresponds to a developer of the web application, such that the user 220 has the access to start the web application. The computer system 202 utilizes the set of parameters to determine the set of authorization plugins. The set of authorization plugins 208 includes at least the first authorization plugin, the second authorization plugin, and a third authorization plugin.

At 308, a request relay model application operation is executed. In the request relay model application operation, the computer system 202 applies the request relay model 210 to the request 202A. The request relay model 210 determines a format of the request 202A. The format of the request 202A includes a request line associated with the request 202A, a header section associated with the request 202A, and a body section associated with the request 202A.

The request line associated with the request 202A includes a method associated with the request 202A, and an HTTP version associated with the request 202A. By way of example, and not by limitation, the method associated with the request 202A is a ‘GET’ operation, and the HTTP version associated with the request is ‘HTTP/1.1’. The header section associated with the request 202A is indicative of a key-value pair that is separated by a colon. By way of example, and not by limitation, the header section is ‘Host: abc.com’. The header section includes a blank line indicative of the end of the header section. The body section associated with the request 202A includes the data present in the request 202A. By way of example, and not by limitation, the data present in the body section is ‘Email: abc@xyz.com’.

The request relay model 210 validates the format of the request 202A by comparing the format of the request 202A to an expected format of the request 202A. The expected format of the request 202A corresponds to a format of the request 202A that can be processed by the request relay model 210 to transmit to the set of authorization plugins 208. The request relay model 210 further determines a routing logic for the request 202A. The routing logic corresponds to a set of rules that determine a route for data packets that are transmitted from a source (e.g., the request relay model 210) to a destination (e.g., the set of authorization plugins 208). The set of rules corresponds to a framework of protocols that determine the manner in which the data packets are directed from the source to the destination. By way of example, the routing logic corresponds to the utilization of a standard internet connection to route data packets associated with the request 202A from the request relay model 210 to the set of authorization plugins 208.

At 310, a request transmission operation is executed. In the request transmission operation, the request relay model 210 transmits the request 202A to each authorization plugin of the set of authorization plugins 208. In an embodiment of the disclosure, the request relay model 210 simultaneously transmits the request 202A to each authorization plugin of the set of authorization plugins 208. By way of example, and not by limitation, the request 202A is associated with a user authentication service provided by the containerized platform 206. The request 202A includes an Application Programming Interface (API) key and an authentication token that is utilized by the set of authorization plugins 208 to authenticate the user 220. The request 202A associated with the user authentication service is authenticated by one of the API key of the request 202A, or the authentication token of the request 202A. The request relay model 210 simultaneously transmits the request 202A to the first authorization plugin of the set of authorization plugins 208 and the second authorization plugin of the set of authorization plugins 208. The first authorization plugin authenticates the request 202A by utilizing the API key of the request 202A, and the second authorization plugin authenticates the request 202A by utilizing the authentication token of the request 202A. The first subset of authorization plugins authenticates the request 202A by utilizing the API key of the request 202A, and the second subset of authorization plugins authenticates the request 202A by utilizing the authentication token of the request 202A. In an embodiment of the disclosure, transmission of the request 202A by the request relay model 210 to the second authorization plugin is independent of the response of the request 202A generated by the first authorization plugin. Therefore, in such a case, the request relay model 210 simultaneously transmits the request 202A to the first authorization plugin and the second authorization plugin.

In an alternate embodiment of the disclosure, the request relay model 210 sequentially transmits the request 202A to each authorization plugin of the set of authorization plugins 208. By way of example, and not by limitation, the request 202A is associated with the user authentication service provided by the containerized platform 206. The request 202A includes the API key and the authentication token that is utilized to authenticate the user 220. The request 202A associated with the user authentication service is first authenticated by utilizing the API key. In case the user authentication is denied by utilizing the API key of the request 202A, the request 202A is authenticated by utilizing the authentication token of the request 202A. The request relay model 210 transmits the request 202A to the first authorization plugin which authenticates the request 202A by utilizing the API key of the request 202A. In case the response of the request 202A generated by the first authorization plugin indicates successful authentication of the request 202A, the request relay model transmits the request 202A to the third authorization plugin upon the reception of the response from the first authorization plugin. The third authorization plugin authenticates the request 202A by utilizing the API key of the request 202A. In case the response of the request 202A generated by the first authorization plugin indicates denial of the authentication of the request 202A, the request relay model 210 transmits the request 202A to the second authorization plugin, upon the reception of the response from the first authorization plugin. The second authorization plugin authenticates the request 202A by utilizing the authentication token of the request 202A. In an embodiment of the disclosure, transmission of the request 202A by the request relay model 210 to one of the second authorization plugin, or the third authorization plugin is dependent on the response of the request 202A generated by the first authorization plugin. Therefore, in such a case, the request relay model 210 sequentially transmits the request 202A to one of the second authorization plugin (upon denial of authentication of the request 202A by the first authorization plugin), or the third authorization plugin (upon the grant of authentication of the request 202A by the first authorization plugin).

At 312, a response determination operation is executed. In the response determination operation, the computer system 202 utilizes the set of authorization plugins 208 to determine the set of responses 212. In an embodiment of the disclosure, the response of the set of responses 212 is determined based on the transmission of the request 202A to the authorization plugin of the set of authorization plugins 208. Each response of the set of responses 212 is associated with the request 202A.

Each authorization plugin of the set of authorization plugins 208 analyzes the request 202A based on a set of policies. The set of policies includes a role-based policy, and a restriction-based policy. The role-based policy determines whether the source associated with the request 202A has permission to access the resource 204A. By way of example, and not by limitation, the role-based policy determines whether the user 220 has the permission to access the resource 204A based on the role of the user 220. For example, the user 220 is the ‘developer’ of the web application. The user 220 has the permission to access the web application. The restriction-based policy determines whether the request 202A overcomes restrictions associated with the access of the resource 204A. By way of example, and not by limitation, the request 202A associated with the user 220 corresponds to privileged access of the resource 204A. The authorization plugin associated with the request 202A denies the privileged access to the resource 204A. The privileged access to the resource 204A provides complete access of the resource 204A to the user 220 which is insecure as per the restriction-based policy.

In an embodiment of the disclosure, the response of the set of responses 212 is determined based on the analysis of the request 202A by the authorization plugin of the set of authorization plugins 208. Each response of the set of responses 212 is associated with the request 202A. The request relay model 210 further forwards the set of responses 212 to the computer system 202.

At 314, a response analyzer model application operation is executed. In the response analyzer model application operation, the computer system 202 applies the response analyzer model 214 to the set of responses 212 received from the request relay model 210. In an embodiment of the disclosure, the response analyzer model 214 determines the set of values associated with the set of responses 212 based on the set of responses 212. The response analyzer model 214 further identifies the subset of responses from the set of responses 212 based on the set of values. The response analyzer model 214 further calculates the score associated with the set of responses 212 based on the count of the set of authorization plugins 208 and the count of the subset of responses. The response analyzer model 214 further compares the score with the security threshold value associated with the security level of the set of security levels 216. Details about applying the response analyzer model 214 to the set of responses 212 to determine the comparison result are provided in FIG. 4, and its corresponding description.

In an alternate embodiment of the disclosure, the response analyzer model 214 generates the analysis data based on the set of responses 212. The response analyzer model 214 generates analysis data based on the analysis of the set of responses 212. In various embodiments of the disclosure, the analysis data includes the set of responses 212 and the count of the set of responses 212. In various embodiments of the disclosure, the analysis data includes the access result. The computer system 202 utilizes the analysis data to determine the one or more authorization plugins of the set of authorization plugins 208. Each authorization plugin of the one or more authorization plugins is associated with an anomaly in the determination of the response associated with the request 202A. Details about the analysis data are provided, in FIG. 5 and its corresponding description. Details about applying the response analyzer model 214 to the set of responses 212 to generate the analysis data are provided, in FIG. 5 and its corresponding description. Details about the determination of the one or more authorization plugins are provided, in FIG. 6 and its corresponding description.

At 316, an access control operation is executed. In the access control operation, the computer system 202 controls the access to the resource 204A associated with the containerized platform 206 based on the set of security levels and the application of the response analyzer model 214 to the set of responses 212. The computer system 202 compares the score associated with the set of responses 212 with the security threshold value. The security threshold value is associated with the security level of the set of security levels 216. In an embodiment of the disclosure, the control of the access to the resource 204A corresponds to the grant of the access to the resource 204A associated with the containerized platform 206. In an alternate embodiment of the disclosure, the control of the access to the resource 204A corresponds to the denial of the access to the resource 204A associated with the containerized platform 206. Details about controlling the access to the resource 204A based on the comparison result are provided, in FIG. 4 and its corresponding description.

FIG. 4 is a diagram that illustrates a second set of exemplary operations for controlling resource access requests in the containerized platform, in accordance with an embodiment of the disclosure. FIG. 4 is explained in conjunction with elements from FIG. 1, FIG. 2, and FIG. 3. With reference to FIG. 4, there is shown the block diagram 400 that illustrates the second set of exemplary operations from 402 to 416, as described herein. The second set of exemplary operations illustrated in the block diagram 400 start at 402 and are performed by any computing system, apparatus, or device, such as by the computer 102 of FIG. 1 or by the computer system 202 of FIG. 2. Although illustrated with discrete blocks, the second set of exemplary operations associated with one or more blocks of the block diagram 400 can be divided into additional blocks, combined into fewer blocks, or eliminated, depending on the implementation.

At 402, the response analyzer model application operation is executed. In the response analyzer model application operation, the computer system 202 applies the response analyzer model 214 to the set of responses 212. In an embodiment of the disclosure, the computer system 202 receives the set of responses 212 from the request relay model 210. The computer system 202 further applies the response analyzer model 214 to the received set of responses 212.

At 404, a value determination operation is executed. In the value determination operation, the response analyzer model 214 determines the set of values associated with the set of responses. The response analyzer model 214 analyzes the set of responses 212 to determine the set of values. The response analyzer model 214 analyzes each response of the set of responses 212 to determine if the response of the set of responses 212 is indicative of the grant of access to the resource 204A or denial of the access to the resource 204A. Upon the analysis of each response of the set of responses 212, the computer system 202 determines the set of values associated with the set of responses 212. In an embodiment of the disclosure, the set of values includes a first value. The first value is indicative of the grant of the access to the resource 204A associated with the containerized platform 206. For example, the set of responses 212 includes the first response and the second response. The first response and the second response correspond to the grant of access to the resource 204A. In an alternate embodiment of the disclosure, the set of values includes a second value. The second value is indicative of the denial of the access to the resource 204A associated with the containerized platform 206. For example, the set of responses 212 includes the first response and the second response. The first response and the second response correspond to the denial of access to the resource 204A. In various embodiments of the disclosure, the set of values includes the first value and the second value. For example, the set of responses 212 includes the first response and the second response. The first response corresponds to the grant of access to the resource 204A. The second response corresponds to denial of the access to the resource 204A.

At 406, a subset identification operation is executed. In the subset identification operation, the response analyzer model 214 identifies the subset of responses from the set of responses 212 based on the set of values. In an embodiment of the disclosure, the response analyzer model 214 identifies the subset of responses from the set of responses 212 based on the first value. Each response of the subset of responses is indicative of the grant of the access to the resource 204A associated with the containerized platform 206. By way of example, and not by limitation, the set of responses 212 includes the first response indicative of the grant of the access to the resource 204A, the second response indicative of the grant of the access to the resource 204A, and a third response indicative of the denial of the access to the resource 204A. The response analyzer model 214 identifies the subset of responses based on the first value. The subset of responses includes the first response, and the second response.

In an alternate embodiment of the disclosure, the response analyzer model 214 identifies the subset of responses from the set of responses 212 based on the second value. Each response of the subset of responses is indicative of the denial of the access to the resource 204A associated with the containerized platform 206. By way of example, and not by limitation, the set of responses 212 includes the first response indicative of the denial of the access to the resource 204A, the second response indicative of the grant of the access to the resource 204A, and the third response indicative of the denial of the access to the resource 204A. The response analyzer model 214 identifies the subset of responses based on the second value. The subset of responses includes the first response, and the third response.

At 408, a score calculation operation is executed. In the score calculation operation, the response analyzer model 214 calculates the score associated with the set of responses 212. The score is determined based on the count of the set of authorization plugins 208 and the count of the subset of responses. In an embodiment of the disclosure, the score is indicative of a ratio of the count of the set of authorization plugins 208 to the count of the subset of responses. The count of the subset of responses is divided by the count of the set of authorization plugins 208 to calculate the score associated with the set of responses 212. By way of example, and not by limitation, the score lies between a range from ‘0’ to ‘1’. The count of the subset of responses is 8, and the count of the set of authorization plugins 208 is 10. The score indicative of the ratio of the count of the subset of responses and the count of the set of authorization plugins 208 is 0.8.

In an alternate embodiment of the disclosure, the score is indicative of the ratio of the count of the set of responses 212 and the count of the subset of responses such that the count of the set of responses 212 is equal to the count of the set of authorization plugins 208. By way of example, and not by limitation, the count of the subset of responses is ‘7’, and the count of the set of responses 212 is ‘10’. The score indicative of the ratio of the count of the subset of responses and the count of the set of responses 212 corresponds to ‘0.7’.

At 410, a score comparison operation is executed. In the score comparison operation, the response analyzer model 214 compares the score with the security threshold value. The security threshold value is indicative of a numerical value associated with the security level of the set of security levels. The security level of the set of security levels 216 is indicative of the degree of protection vital for the grant or the denial of the access to the resource 204A. The response analyzer model 214 determines the comparison result based on the comparison of the score with the security threshold value. The computer system 202 further utilizes the comparison result to control the access to the resource 204A associated with the containerized platform 206. By way of example, the score associated with the set of responses 212 is 0.8 and the security threshold value is 0.9. The response analyzer model 214 determines the comparison result by comparing the score with the security threshold value. The comparison result indicates that the score is greater than the security threshold value.

At 412, the computer system 202 determines if the score is greater than the security threshold value. In an embodiment of the disclosure, the computer system 202 transfers the control of the operations to 414 based on the determination that the score is less than or equal to the security threshold value. In an alternate embodiment of the disclosure, the control of operations is transferred to 416 based on the determination that the score is greater than the security threshold value.

The computer system 202 further determines the access result based on the determination if the score is greater than the security threshold value. In an embodiment of the disclosure, the computer system 202 determines the access result indicative of the grant of the access to the resource 204A based on the determination that the score is greater than the security threshold value. In an alternate embodiment of the disclosure, the computer system 202 determines the access result indicative of the denial of the access to the resource 204A based on the determination that the score is less than or equal to the security threshold value.

At 414, an access denial operation is executed. In the access denial operation, the computer system 202 controls the access to the resource 204A associated with the containerized platform 206 based on the determination of the score being less than or equal to the security threshold value. The control of the access to the resource 204A corresponds to the denial of the access to the resource 204A associated with the containerized platform 206. By way of example, and not by limitation, if the score is 0.5 and the security threshold value is 0.8, then the computer system 202 may deny the access to the resource 204A because the score 0.5 is less than the security threshold value 0.8. In an embodiment of the disclosure, the computer system 202 outputs an alert indicative of the denial of the access to the resource 204A on the user device 218.

At 416, an access grant operation is executed. In the access grant operation, the computer system 202 controls the access to the resource 204A associated with the containerized platform 206 based on the determination of the score being greater than the security threshold value. The control of the access to the resource 204A corresponds to the grant of the access to the resource 204A associated with the containerized platform 206. By way of example, and not by limitation, if the score is 0.9 and the security threshold value is 0.8, then the computer system 202 may deny the access to the resource 204A because the score 0.9 is greater than the security threshold value 0.8. In an embodiment of the disclosure, the computer system 202 outputs the alert indicative of the grant of the access to the resource 204A on the user device 218.

FIG. 5 is a diagram that illustrates exemplary operations for generating analysis data based on application of the response analyzer model to the set of responses, in accordance with an embodiment of the disclosure. FIG. 5 is explained in conjunction with elements from FIG. 1, FIG. 2, FIG. 3, and FIG. 4. With reference to FIG. 5, there is shown the block diagram 500 that illustrates exemplary operations from 502 to 508, as described herein. The exemplary operations illustrated in the block diagram 500 start at 502 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 500 can be divided into additional blocks, combined into fewer blocks, or eliminated, depending on the implementation.

At 502, the response analyzer model application operation is executed. In the response analyzer model application operation, the computer system 202 applies the response analyzer model 214 to the set of responses 212. In an embodiment of the disclosure, the computer system 202 receives the set of responses 212 from the request relay model 210. The computer system 202 further applies the response analyzer model 214 to the received set of responses 212 to analyze the set of responses 212.

At 504, a response analysis operation is executed. In the response analysis operation, the response analyzer model 214 analyzes the set of responses 212. In an embodiment of the disclosure, the response analyzer model 214 groups the set of responses 212 based on a similarity between each response of the set of responses 212. In various embodiments of the disclosure, the response analyzer model 214 generates a first group of the set of responses 212 based on a determination that each response of the set of responses 212 present in the first group is indicative of the grant of the access to the resource 204A. In various embodiments of the disclosure, the response analyzer model 214 generates a second group of the set of responses 212 based on a determination that each response of the set of responses 212 present in the second group is indicative of the denial of the access to the resource 204A.

The response analyzer model 214 determines a count of the responses present in the first group and the second group. The response analyzer model 214 further utilizes the count of the responses present in the first group and the second group to generate the analysis data. In an embodiment of the disclosure, the response analyzer model 214 compares each element of the first group with the access result to generate the analysis data. In an embodiment of the disclosure, the response analyzer model 214 compares each element of the second group with the access result to generate the analysis data.

At 506, an analysis data generation operation is executed. In the analysis data generation operation, the response analyzer model 214 generates analysis data 506A based on the analysis of the set of responses 212. In various embodiments of the disclosure, the analysis data 506A includes the set of responses 212 and the count of the set of responses 212. In various embodiments of the disclosure, the analysis data 506A includes the access result. In various embodiments of the disclosure, the analysis data 506A includes the count of the responses present in the first group (each response of the first group is indicative of the grant of the access to the resource 204A). In various embodiments of the disclosure, the analysis data 506A includes the count of the responses present in the second group (each response of the second group is indicative of the denial of the access to the resource 204A).

In various embodiments of the disclosure, the analysis data 506A includes patterns associated with the set of responses 212 based on the type of the request 202A, the source of the request 202A, the resource type associated with the request 202A, or a combination thereof. By way of example, and not by limitation, the pattern associated with the set of responses 212 is indicative of the grant of the access to the resource 204A. The pattern is determined based on the type of the request 202A. The type of the request 202A is indicative of the ‘GET’ operation. The pattern associated with the request 202A is indicative of the probability of the grant of the access to the resource 204A is 0.9. By way of example, and not by limitation, the type of the request 202A is indicative of the ‘POST’ operation. The pattern associated with the request 202A is indicative of the probability of the grant of the access to the resource 204A is 0.7. In an embodiment of the disclosure, the computer system 202 utilizes the analysis data 506A to determine the one or more authorization plugins. Details about determining the one or more authorization plugins based on the analysis data 506A are provided, in FIG. 6 and its corresponding description.

At 508, an analysis data output operation is executed. In the analysis data output operation, the response analyzer model 214 outputs the analysis data 506A. In an embodiment of the disclosure, the computer system 202 outputs the analysis data 506A indicative of the set of responses 212 on the user device 218. In an alternate embodiment of the disclosure, the computer system 202 outputs the analysis data 506A indicative of the access result on the user device 218.

FIG. 6 is a diagram that illustrates exemplary operations for determining the one or more authorization plugins associated with an anomaly in determination of responses, in accordance with an embodiment of the disclosure. FIG. 6 is explained in conjunction with elements from FIG. 1, FIG. 2, FIG. 3, FIG. 4, and FIG. 5. With reference to FIG. 6, there is shown the block diagram 600 that illustrates exemplary operations from 602 to 608, as described herein. The exemplary operations illustrated in the block diagram 600 start at 602 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 600 can be divided into additional blocks, combined into fewer blocks, or eliminated, depending on the implementation.

At 602, a response comparison operation is executed. In the response comparison operation, the computer system 202 utilizes the analysis data 506A to compare each response of the set of responses 212 with the access result. The analysis data 506A includes the set of responses 212 and the access result. In an embodiment of the disclosure, the computer system 202 compares each response of the set of responses 212 with the access result indicative of the grant of the access to the resource 204A. In an alternate embodiment of the disclosure, the computer system 202 compares each response of the set of responses 212 with the access result indicative of the denial of the access to the resource 204A.

At 604, a response identification operation is executed. In the response identification operation, the computer system 202 identifies the one or more responses from the set of responses 212 based on the comparison of each response of the set of responses 212 with the access result. Each response of the set of responses is different from the access result. By way of example, and not by limitation, the access result is indicative of the grant of the access to the resource 204A. Each response of the one or more responses is indicative of the denial of the access to the resource 204A. By way of example, and not by limitation, the access result is indicative of the denial of the access to the resource 204A. Each response of the one or more responses is indicative of the grant of the access to the resource 204A.

At 606, an authorization plugin identification operation is executed. In the authorization plugin identification operation, the computer system 202 identifies the one or more authorization plugins of the set of authorization plugins 208 based on the one or more responses. The one or more responses are associated with the one or more authorization plugins. The one or more responses are generated by the one or more authorization plugins. Each authorization plugin of the one or more authorization plugins is associated with the corresponding response of the one or more responses.

Each authorization plugin of the one or more authorization plugins is associated with an anomaly in the determination of the response associated with the request 202A. An anomaly is defined as any deviation from the expected behavior or performance of the authorization plugin in the determination of the response associated with the request 202A. The response associated with the corresponding authorization plugin of the one or more authorization plugins is different from the access result. By way of example, and not by limitation, each response of the one or more responses is indicative of the denial of the request 202A and the access result is indicative of the grant of the access to the resource 204A. The computer system 202 identifies the one or more authorization plugins of the set of authorization plugins 208 based on the determination that each response of the one or more responses indicative of the denial of the access to the resource 204A is different from the access result indicative of the grant of the access to the resource 204A.

By way of example, and not by limitation, each response of the one or more responses is indicative of the grant of the request 202A and the access result is indicative of the denial of the access to the resource 204A. The computer system 202 identifies the one or more authorization plugins of the set of authorization plugins 208 based on the determination that each response of the one or more responses indicative of the grant of the access to the resource 204A is different from the access result indicative of the denial of the access to the resource 204A.

At 608, an authorization plugin output operation is executed. In the authorization plugin output operation, the computer system 202 outputs the one or more authorization plugins. In an embodiment of the disclosure, the computer system 202 renders the alert indicative of the one or more authorization plugins on the user device 218. The user 220 analyzes the identified one or more authorization plugins. In an embodiment of the disclosure, the user 220, via the user device 218, rectifies the anomaly in the determination of the response of the request 202A by the one or more authorization plugins. For example, if a control policy associated with the determination of the response of the request 202A by the one or more authorization plugins is outdated due to which the one or more authorization plugins are associated with the anomaly, then the user 220, via the user device 218, updates the control policy of the one or more authorization plugins.

In an alternate embodiment of the disclosure, the user 220, via the user device 218, removes the identified one or more authorization plugins from the set of authorization plugins 208. For example, if the set of authorization plugins 208 includes the first authorization plugin, the second authorization plugin, and the third authorization plugin and the identified one or more authorization plugins include the first authorization plugin, then the user 220, via the user device 218, removes the first authorization plugin from the set of authorization plugins 208.

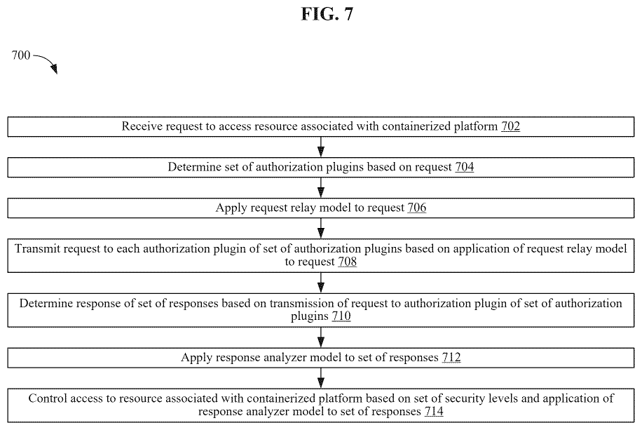

FIG. 7 is a diagram that illustrates a flowchart of a first exemplary method for controlling the resource access requests in the containerized platform, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown a flowchart 700. The operations of the exemplary method may be executed by any computing system, for example, by the computer 102 of FIG. 1 or the computer system 202 of FIG. 2. The operations of the flowchart 700 may start at 702.

At 702, the request 202A to access the resource 204A associated with the containerized platform 206 is received. In an embodiment of the disclosure, the computer system 202 receives the request 202A to access the resource 204A associated with the containerized platform 206. Details about receiving the request 202A are provided, for example, in FIG. 3.

At 704, the set of authorization plugins 208 is determined based on the request 202A. In an embodiment of the disclosure, the computer system 202 determines the set of authorization plugins 208 based on the request 202A. Details about determining the set of authorization plugins 208 based on the request 202A are provided, for example, in FIG. 3.

At 706, the request relay model 210 is applied to the request 202A. In an embodiment of the disclosure, the computer system 202 applies the request relay model 210 to the request 202A. Details about applying the request relay model 210 are provided, for example, in FIG. 3.

At 708, the request 202A is transmitted to each authorization plugin of the set of authorization plugins 208 based on the application of the request relay model 210 to the request 202A. In an embodiment of the disclosure, the computer system 202 transmits the request 202A to each authorization plugin of the set of authorization plugins 208 based on the application of the request relay model 210 to the request 202A. Details about transmitting the request 202A to each authorization plugin of the set of authorization plugins 208 based on the application of the request relay model 210 to the request 202A are provided, for example, in FIG. 3.

At 710, the response of the set of responses 212 is determined based on the transmission of the request 202A to the authorization plugin of the set of authorization plugins 208. Each response of the set of responses 212 is associated with the request 202A. In an embodiment of the disclosure, the computer system 202 determines the response of the set of responses 212 based on the transmission of the request 202A to the authorization plugin of the set of authorization plugins 208. Each response of the set of responses 212 is associated with the request 202A. Details about determining the response of the set of responses 212 based on the transmission of the request 202A to the authorization plugin of the set of authorization plugins 208 are provided, for example, in FIG. 3.

At 712, the response analyzer model 214 is applied to the set of responses 212. In an embodiment of the disclosure, the computer system 202 applies the response analyzer model 214 to the set of responses 212. Details about applying the response analyzer model 214 to the set of responses 212 are provided, for example, in FIG. 3, FIG. 4, and FIG. 5.

At 714, the access to the resource 204A associated with the containerized platform 206 is controlled based on the set of security levels 216 and the application of the response analyzer model 214 to the set of responses 212. In an embodiment of the disclosure, the computer system 202 controls the access to the resource 204A associated with the containerized platform 206 based on the set of security levels 216 and the application of the response analyzer model 214 to the set of responses 212. Details about controlling the access to the resource 204A associated with the containerized platform 206 based on the set of security levels 216 and the application of the response analyzer model 214 to the set of responses 212 are provided, for example, in FIG. 3 and FIG. 4.

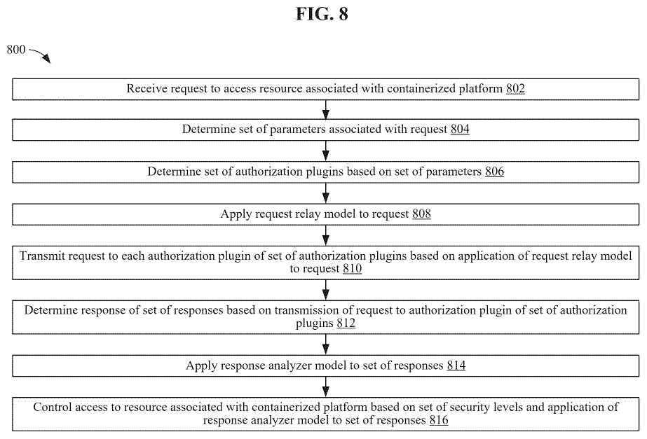

FIG. 8 is a diagram that illustrates a flowchart of a second exemplary method for controlling resource access requests in the containerized platform, in accordance with an embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, there is shown a flowchart 800. The operations of the exemplary method may be executed by any computing system, for example, by the computer 102 of FIG. 1 or the computer system 202 of FIG. 2. The operations of the flowchart 800 may start at 802.

At 802, the request 202A to access the resource 204A associated with the containerized platform 206 is received. In an embodiment of the disclosure, the computer system 202 receives the request 202A to access the resource 204A associated with the containerized platform 206. Details about receiving the request 202A are provided, for example, in FIG. 3.

At 804, the set of parameters associated with the request 202A is determined. The set of parameters includes at least one of the type of the request 202A, the source of the request 202A, or the resource type associated with the request 202A. In an embodiment of the disclosure, the computer system 202 determines the set of parameters associated with the request 202A. The set of parameters includes at least one of the type of the request 202A, the source of the request 202A, or the resource type associated with the request 202A. Details about determining the set of parameters associated with the request 202A are provided, for example, in FIG. 3.

At 806, the set of authorization plugins 208 is determined based on the set of parameters. In an embodiment of the disclosure, the computer system 202 determines the set of authorization plugins 208 based on the set of parameters. Details about determining the set of authorization plugins 208 based on the set of parameters are provided, for example, in FIG. 3.

At 808, the request relay model 210 is applied to the request 202A. In an embodiment of the disclosure, the computer system 202 applies the request relay model 210 to the request 202A. Details about applying the request relay model 210 are provided, for example, in FIG. 3.

At 810, the request 202A is transmitted to each authorization plugin of the set of authorization plugins 208 based on the application of the request relay model 210 to the request 202A. In an embodiment of the disclosure, the computer system 202 transmits the request 202A to each authorization plugin of the set of authorization plugins 208 based on the application of the request relay model 210 to the request 202A. Details about transmitting the request 202A to each authorization plugin of the set of authorization plugins 208 based on the application of the request relay model 210 to the request 202A are provided, for example, in FIG. 3.

At 812, the response of the set of responses 212 is determined based on the transmission of the request 202A to the authorization plugin of the set of authorization plugins 208. Each response of the set of responses 212 is associated with the request 202A. In an embodiment of the disclosure, the computer system 202 determines the response of the set of responses 212 based on the transmission of the request 202A to the authorization plugin of the set of authorization plugins 208. Each response of the set of responses 212 is associated with the request 202A. Details about determining the response of the set of responses 212 based on the transmission of the request 202A to the authorization plugin of the set of authorization plugins 208 are provided, for example, in FIG. 3.

At 814, the response analyzer model 214 is applied to the set of responses 212. In an embodiment of the disclosure, the computer system 202 applies the response analyzer model 214 to the set of responses 212. Details about applying the response analyzer model 214 to the set of responses 212 are provided, for example, in FIG. 3, FIG. 4, and FIG. 5.

At 816, the access to the resource 204A associated with the containerized platform 206 is controlled based on the set of security levels 216 and the application of the response analyzer model 214 to the set of responses 212. In an embodiment of the disclosure, the computer system 202 controls the access to the resource 204A associated with the containerized platform 206 based on the set of security levels 216 and the application of the response analyzer model 214 to the set of responses 212. Details about controlling the access to the resource 204A associated with the containerized platform 206 based on the set of security levels 216 and the application of the response analyzer model 214 to the set of responses 212 are provided, for example, in FIG. 3 and FIG. 4.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
receiving, by a computer, a request to access a resource associated with a containerized platform;
determining, by the computer, a set of authorization plugins based on the request;
applying, by the computer, a request relay model to the request;
transmitting, by the computer, the request to each authorization plugin of the set of authorization plugins based on the application of the request relay model to the request;
determining, by the computer, a response of a set of responses based on the transmission of the request to an authorization plugin of the set of authorization plugins, wherein each response of the set of responses is associated with the request;
applying, by the computer, a response analyzer model to the set of responses; and
controlling, by the computer, the access to the resource associated with the containerized platform based on a set of security levels and the application of the response analyzer model to the set of responses.

2. The computer-implemented method of claim 1, further comprising:
determining, by the computer, a set of parameters associated with the request, wherein the set of parameters comprises at least one of a type of the request, a source of the request, or a resource type associated with the request; and
determining, by the computer, the set of authorization plugins based on the set of parameters.

3. The computer-implemented method of claim 1, wherein the application of the response analyzer model to the set of responses further comprises:
determining, by the computer, a set of values associated with the set of responses;
identifying, by the computer, a subset of responses from the set of responses based on the set of values;
calculating, by the computer, a score associated with the set of responses based on a count of the set of authorization plugins and a count of the subset of responses; and
comparing, by the computer, the score and a security threshold value, wherein the security threshold value is associated with a security level of the set of security levels.

4. The computer-implemented method of claim 3, further comprising:
determining, by the computer, the score is greater than the security threshold value based on the comparison of the score with the security threshold value; and
controlling, by the computer, the access to the resource associated with the containerized platform based on the determination of the score being greater than the security threshold value, wherein the controlling of the access to the resource corresponds to a grant of the access to the resource associated with the containerized platform.

5. The computer-implemented method of claim 3, further comprising:
determining, by the computer, the score is less than the security threshold value based on the comparison of the score with the security threshold value; and
controlling, by the computer, the access to the resource associated with the containerized platform based on the determination of the score being less than the security threshold value, wherein the controlling of the access to the resource corresponds to a denial of the access to the resource associated with the containerized platform.

6. The computer-implemented method of claim 1, wherein the application of the response analyzer model to the set of responses further comprises:
analyzing, by the computer, the set of responses;
generating, by the computer, analysis data based on the analysis of the set of responses; and
outputting, by the computer, the analysis data comprising the set of responses and an access result indicative of one of a grant of the access to the resource or a denial of the access to the resource.

7. The computer-implemented method of claim 6, further comprising:
comparing, by the computer, each response of the set of responses with the access result based on the analysis data;
identifying, by the computer, one or more responses from the set of responses based on the comparison of each response of the set of responses with the access result, wherein each response of the one or more responses is different from the access result;
identifying, by the computer, one or more authorization plugins of the set of authorization plugins based on the one or more responses, wherein the one or more responses are associated with the one or more authorization plugins; and
outputting, by the computer, the one or more authorization plugins.

8. A computer system, comprising:
a processor set;
one or more computer-readable storage media; and
program instructions stored on the one or more computer-readable storage media, the program instructions executable by the processor set to cause the processor set to:
receive a request to access a resource associated with a containerized platform;
determine a set of parameters associated with the request, wherein the set of parameters comprises at least one of a type of the request, a source of the request, or a resource type associated with the request;
determine a set of authorization plugins based on the set of parameters;
apply a request relay model to the request;
transmit the request to each authorization plugin of the set of authorization plugins based on the application of the request relay model to the request;
determine a response of a set of responses based on the transmission of the request to an authorization plugin of the set of authorization plugins, wherein each response of the set of responses is associated with the request;
apply a response analyzer model to the set of responses; and
control the access to the resource associated with the containerized platform based on a set of security levels and the application of the response analyzer model to the set of responses.

9. The computer system of claim 8, wherein the application of the response analyzer model to the set of responses further cause the processor set to:
determine a set of values associated with the set of responses;
identify a subset of responses from the set of responses based on the set of values;
calculate a score associated with the set of responses based on a count of the set of authorization plugins and a count of the subset of responses; and
compare the score and a security threshold value, wherein the security threshold value is associated with a security level of the set of security levels.

10. The computer system of claim 9, wherein the program instructions further cause the processor set to:
determine the score is greater than the security threshold value based on the comparison of the score with the security threshold value; and
control the access to the resource associated with the containerized platform based on the determination of the score being greater than the security threshold value, wherein the control of the access to the resource corresponds to a grant of the access to the resource associated with the containerized platform.

11. The computer system of claim 9, wherein the program instructions further cause the processor set to:
determine the score is less than the security threshold value based on the comparison of the score with the security threshold value; and
control the access to the resource associated with the containerized platform based on the determination of the score being less than the security threshold value, wherein the control of the access to the resource corresponds to a denial of the access to the resource associated with the containerized platform.

12. The computer system of claim 8, wherein the application of the response analyzer model to the set of responses further cause the processor set to:
analyze the set of responses;
generate analysis data based on the analysis of the set of responses; and
output the analysis data, wherein the analysis data comprises the set of responses and an access result indicative of one of a grant of the access to the resource or a denial of the access to the resource.

13. The computer system of claim 12, wherein the program instructions further cause the processor set to:
compare each response of the set of responses with the access result based on the generated analysis data;
identify one or more responses from the set of responses based on the comparison of each response of the set of responses with the access result, wherein each response of the one or more responses is different from the access result;
identify one or more authorization plugins of the set of authorization plugins based on the one or more responses, wherein the one or more responses are associated with the one or more authorization plugins; and
output the one or more authorization plugins.

14. A computer-program product to control an access to a resource associated with a containerized platform, the computer-program product comprising:
one or more computer-readable storage media; and
program instructions stored on the one or more computer-readable storage media to perform operations comprising:
receiving a request to access the resource associated with the containerized platform;
determining a set of authorization plugins based on the request;
applying a request relay model to the request;
transmitting the request to each authorization plugin of the set of authorization plugins based on the application of the request relay model to the request;
determining a response of a set of responses based on the transmission of the request to an authorization plugin of the set of authorization plugins, wherein each response of the set of responses is associated with the request;
applying a response analyzer model to the set of responses; and
controlling the access to the resource associated with the containerized platform based on a set of security levels and the application of the response analyzer model to the set of responses.

15. The computer-program product of claim 14, wherein the program instructions stored on the one or more computer-readable storage media perform the operations further comprising:
determining a set of parameters associated with the request, wherein the set of parameters comprises at least one of a type of the request, a source of the request, or a resource type associated with the request; and
determining the set of authorization plugins based on the set of parameters.

16. The computer-program product of claim 14, wherein the program instructions stored on the one or more computer-readable storage media perform the operations, and wherein the operations for the application of the response analyzer model to the set of responses further comprises:
determining a set of values associated with the set of responses;
identifying a subset of responses from the set of responses based on the set of values;
calculating a score associated with the set of responses based on the set of authorization plugins and the subset of responses; and
comparing the score and a security threshold value, wherein the security threshold value is associated with a security level of the set of security levels.

17. The computer-program product of claim 16, wherein the program instructions stored on the one or more computer-readable storage media perform the operations further comprising:
determining the score is greater than the security threshold value based on the comparison of the score with the security threshold value; and
controlling the access to the resource associated with the containerized platform based on the determination of the score being greater than the security threshold value, wherein the controlling of the access to the resource corresponds to a grant of the access to the resource associated with the containerized platform.

18. The computer-program product of claim 16, wherein the program instructions stored on the one or more computer-readable storage media perform the operations further comprising:
determining the score is less than the security threshold value based on the comparison of the score with the security threshold value; and
controlling the access to the resource associated with the containerized platform based on the determination of the score being less than the security threshold value, wherein the controlling of the access to the resource corresponds to a denial of the access to the resource associated with the containerized platform.

19. The computer-program product of claim 14, wherein the program instructions stored on the one or more computer-readable storage media perform the operations, and wherein the operations for the application of the response analyzer model to the set of responses further comprises:
analyzing the set of responses;
generating analysis data based on the analysis of the set of responses; and
outputting the analysis data comprising the set of responses and an access result indicative of one of a grant of the access to the resource or a denial of the access to the resource.

20. The computer-program product of claim 19, wherein the program instructions stored on the one or more computer-readable storage media perform the operations further comprising:
comparing each response of the set of responses with the access result based on the generated analysis data;
identifying one or more responses from the set of responses based on the comparison of each response of the set of responses with the access result, wherein each response of the one or more responses is different from the access result;
identifying one or more authorization plugins of the set of authorization plugins based on the one or more responses, wherein the one or more responses are associated with the one or more authorization plugins; and
outputting the one or more authorization plugins.
